(19) United States
(12) Patent Application Publication
(10) Pub. No.: US 2014/0113110 A1
(43) Pub. Date: Apr. 24, 2014

(54) FLEXIBLE VEHICLE SURFACE PROTECTOR WITH RIGID NIBS

(71) Applicant: WINFIELD CONSUMER PRODUCTS, INC., Winfield, KS (US)

(72) Inventors: Kenneth Douglas Johnson, Derby, KS (US); Robert D. Tyler, Winfield, KS (US)

(73) Assignee: Winfield Consumer Products, Inc., Winfield, KS (US)

(21) Appl. No.: 13/800,919

(22) Filed: Mar. 13, 2013

Related U.S. Application Data
(60) Provisional application No. 61/716,035, filed on Oct. 19, 2012.

(51) Int. Cl. B60N 3/04; B29C 65/70

(52) U.S. Cl. CPC B60N 3/048; B29C 65/70
USPC 428/172; 264/250

(57) ABSTRACT

In one aspect, the disclosure describes a surface protector comprising a mat and a nib array. The mat includes a first material having a first hardness value. The nib array includes a second material having a second hardness value greater than the first hardness value. The nib array further includes a plurality of nibs connected by a lattice. In another aspect, the disclosure describes a method for making a surface protector. The method includes forming a nib array including a first material having a first hardness value. The nib array further includes a plurality of nibs connected by a lattice. The method includes attaching a mat to the nib array, the mat including a second material having a second hardness value less than the first hardness value.

### CROSS-REFERENCE TO RELATED APPLICATION

The present application is based on and claims the benefit of U.S. provisional patent application Ser. No. 61/716,035, filed Oct. 19, 2012, the content of which is hereby incorporated by reference in its entirety.

### BACKGROUND

Mats are often placed over the floor board of a vehicle to protect the floor surface covering, such as in areas including the foot wells of the vehicle, a cargo space, and a trunk, for example. Particularly, mats are useful for protecting the carpet or other floor covering from becoming worn, stained or otherwise damaged by the occupants of the vehicle or items stored in the vehicle.

Protective vehicle mats come in a variety of shapes and sizes. One typical prior art mat is a mat constructed from a flat sheet made of fabric, rubber or plastic material. The mats are typically flexible and are laid across the floor board surface of the vehicle. One drawback of this type of mat is that it tends to slide across the floor board due to the forces applied by the passengers of the vehicle or by the motion of the vehicle itself. One prior art solution to this problem is to apply protrusions such as nibs to the surface of the mats contacting the floor board. Typically, the nibs are formed as small spikes with pointed ends that grip the floor board surface of the vehicle. The nibs are generally equally distributed across the underlying surface to provide a number of individual contact areas.

### SUMMARY

In one aspect, the disclosure describes a surface protector comprising a mat and a nib array. The mat comprises a first material having a first hardness value. The nib array comprises a second material having a second hardness value greater than the first hardness value. The nib array further comprises a plurality of nibs connected by a lattice.

In another aspect, the disclosure describes a method for making a surface protector. The method comprises forming a nib array comprising a first material having a first hardness value. The nib array further comprises a plurality of nibs connected by a lattice. The method comprises attaching a mat to the nib array, the mat comprising a second material having a second hardness value less than the first hardness value.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

FIG. 1 is a top perspective view of an exemplary nib array of the present disclosure.

FIG. 2 is a top perspective view of the nib array of FIG. 1 incorporated into a flexible vehicle surface protector in a first embodiment.

FIG. 3 is a top perspective view of a second exemplary embodiment of a vehicle surface protector incorporating a nib array of FIG. 1.

FIG. 4 is a side elevation view of the vehicle surface protector of FIG. 2, with the cross section taken at line 4-4 of FIG. 2.

FIG. 5 is a side elevation view of the floor vehicle surface protector of FIG. 3, taken along line 5-5 of FIG. 3.

The disclosed subject matter will be further explained with reference to the attached figures, wherein like structure or system elements are referred to by like reference numerals throughout the several views.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

The figures may not be drawn to scale. In particular, some features may be enlarged relative to other features for clarity. Moreover, where terms such as above, below, over, under, top, bottom, side, right, left, etc., are used, it is to be understood that they are used only for ease of understanding the description. It is contemplated that structures may be oriented otherwise.

### DETAILED DESCRIPTION

One problem with the state of the art floor mats is that the nibs are formed from the same flexible material as the floor mat. While flexibility of a primary portion of the floor mat is desirable to allow the mat to conform to the contours of a vehicle floor surface, corresponding flexibility in the nibs is generally not desirable because such flexibility allows for excessive deformation of the nibs, thereby compromising the ability of the nibs to hold the floor mat in place. Moreover, a relatively soft and flexible material used for a primary portion of the floor mat is not particularly suitable for the nibs, as they encounter lateral forces in use and may shear off or otherwise wear excessively. Accordingly, this disclosure describes a generally flexible vehicle surface protector with rigid nibs and a method for manufacturing the floor protector. An exemplary method involves injection molding, in which molten material is injected into a mold cavity and cooled to form the final part.

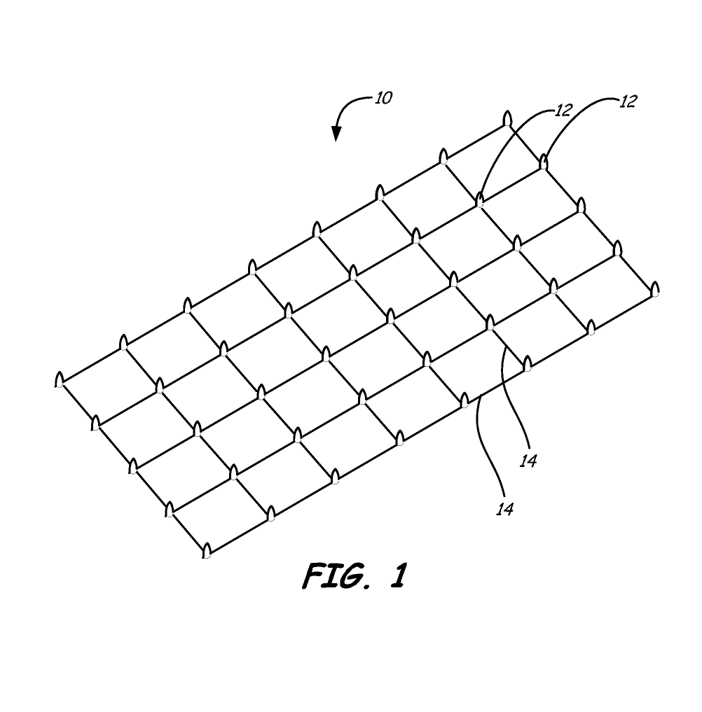

FIG. 1 is a top perspective view of an exemplary nib array 10 of the present disclosure. In an exemplary embodiment, nib array 10 comprises a plurality of nibs 12 connected by a lattice 14. In an exemplary embodiment, nib array 10 is formed of a relatively rigid polymer such as a glass-filled polypropylene. In an exemplary embodiment, nibs 12 are spaced equally from one another to create an equal dispersion pattern of nibs 12 on lattice 14. However, in other embodiments, it may be desirable to have a higher concentration of nibs in a particular area, such as along a periphery of lattice 14 to enhance gripping at more contoured surfaces of a vehicle floor surface. It is contemplated that many sizes, shapes and spacings of nibs may be used.

In an exemplary embodiment, lattice 14 is composed of relatively thin cross members or connectors, which may be in the form of rods, filaments or the like. The thin cross members or connectors are spaced apart or separated from each other by apertures or openings in the lattice. A primary purpose of lattice 14 is to maintain the spatial distribution of nibs 12 and to keep nibs 12 connected for further processing. Because nib array 10 is made of a relatively rigid material, it is important that lattice 14 is strong enough to not break during handling. Moreover, it is also important that lattice 14 is not so robust that it renders a finished surface protector rigid rather than flexible.

In an exemplary embodiment, lattice 14 is configured as a rectangular grid, as illustrated. However, it is contemplated that other lattice patterns may be used, such as triangular grids, honeycomb patterns, and irregular patterns, for example.

In exemplary embodiments, nib array 10 is formed by open cavity molding, wherein the nib pattern is provided as a pattern of indentations in a bottom mold. A bottom inverse mold, as is known in the art, is filled by first filling in the indentations that will form nibs 12 and then filling in the channels that will form lattice 14.

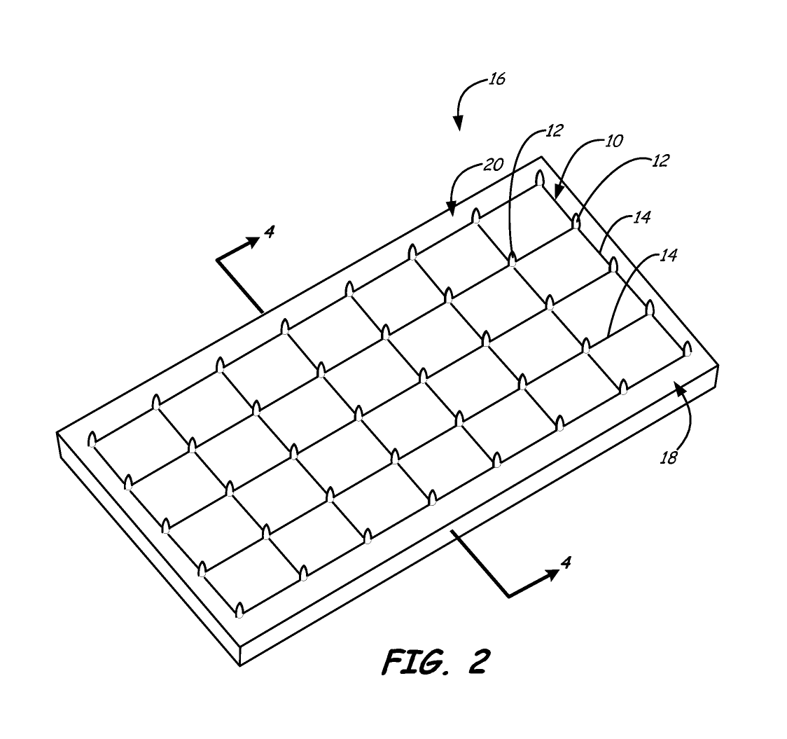

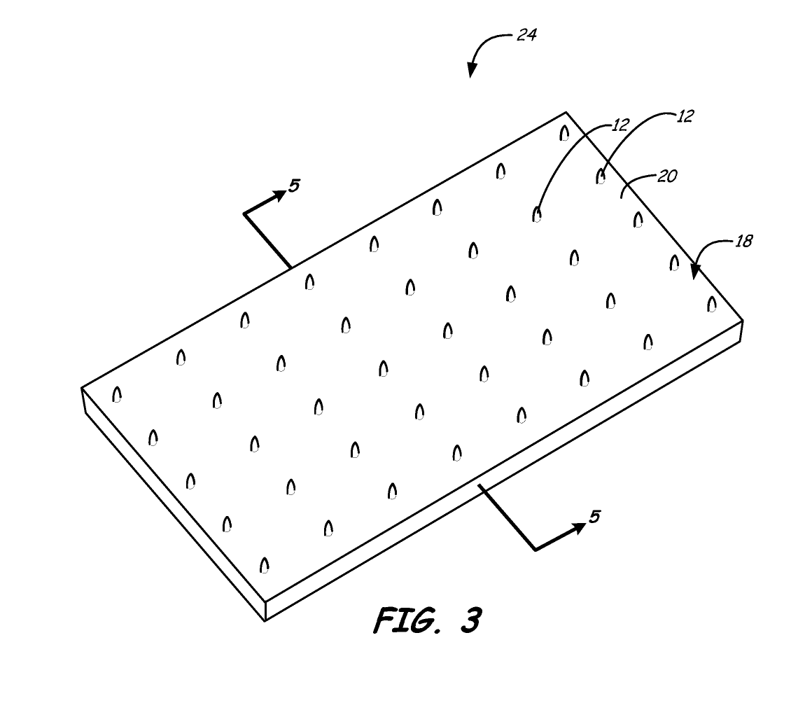

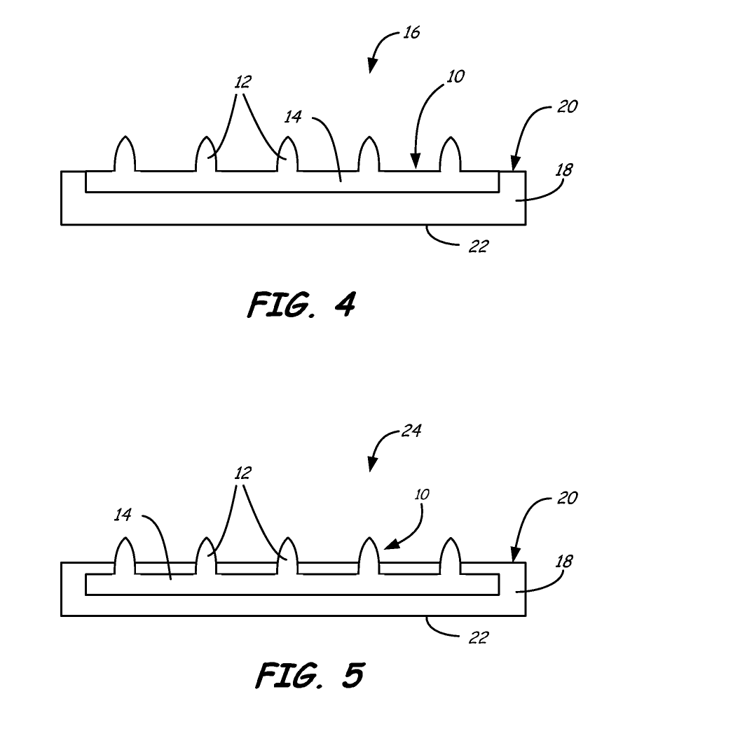

To form the vehicle surface protector 16 shown in FIG. 2, in one exemplary method, nib array 10 is formed in or transferred to a mold die for mat 18, which is subsequently filled with a thermoplastic elastomer material bonds with nib array 10. In one embodiment of a vehicle surface protector 16, as shown in FIGS. 2 and 4, nib array 10 is exposed and therefore remains visible on a back surface 20 of vehicle surface protector 16. Top surface 22 may be further molded to impart surface features thereon, as known in the art, especially by the use of a closed-cavity molding process with bottom and top mold dies. FIGS. 3 and 5 show a second exemplary embodiment of a vehicle surface protector 24. In vehicle surface protector 24, nib array 10 is formed so that lattice 14 is embedded within mat 18 and is not visible on bottom surface 20.

In one method for manufacturing vehicle surface protector 16 shown in FIGS. 2 and 4, nib array 14 remains in a mold die, and the thermoplastic elastomer of mat 18 is supplied in the form of a molten thermoplastic resin so that it may flow onto and around lattice 14. In that method, nib array 14 may or may not be cured before the introduction of the thermoplastic elastomer of mat 18.

In another exemplary method, nib array 10 is allowed to partially or completely cure and mat 18 is over-molded around nib array 10. In an exemplary embodiment, the thermoplastic elastomer of mat 18 is supplied in the form of a molten thermoplastic resin so that it may flow onto and around lattice 14. Moreover, in the embodiment illustrated in FIGS. 3 and 5, it may also flow under lattice 14. Accordingly, the resulting vehicle surface protector 16, 24 has a flexible primary mat portion 18 and relatively rigid and strong nibs 12 projecting from a bottom surface 20 of the mats 18. If desired, nibs 12 for the embodiment of FIGS. 3 and 5 may be longer than for the embodiment of FIGS. 2 and 4 so that the height of nibs 12 protruding out from bottom surface 20 is substantially the same in both cases.

In an exemplary embodiment, the materials chosen for nib array 10 and mat 18 are selected by taking into consideration their properties for fusion bonding with each other, so that in a resulting vehicle surface protector 16, 24, nib array 10 and mat 18 are fused together. For example, when nib array 10 is composed of a polypropylene, an olefinic thermoplastic elastomer is especially suitable for mats 18 because of the desirable fusion bonding properties of these materials.

In an exemplary embodiment, the material for nib array 10 is harder than the material for mat 18. There are two common methods of expressing the hardness of rubber and plastic materials: a durometer reading (or Shore hardness) and Young's modulus of elasticity. A durometer measures the penetration of a metal foot into the surface of a material. There are different durometer scales, but Shore A and Shore D are the most common. Values range from zero for the softest materials to 100 for the hardest. Shore hardness values do not have units. Young's modulus is the ratio of the stress applied to a material to how much it is deformed. Young's modulus of elasticity is in units of pressure. With both Shore hardness and Young's modulus, larger values indicate a harder material.

While relatively planar vehicle surface protectors 16, 24 are illustrated, it is to be understood that they may be contoured as desired to follow the curvatures of the floor surfaces on which they are used. Moreover, other surface features may be included on top surface 22, such as liquid channeling treads, heel pads, and other features common in floor mats.

Although the subject of this disclosure has been described with reference to several embodiments, workers skilled in the art will recognize that changes may be made in form and detail without departing from the spirit and scope of the disclosure. In addition, any feature disclosed with respect to one embodiment may be incorporated in another embodiment, and vice-versa.

What is claimed is:

1. A surface protector comprising:
a mat comprising a first material having a first hardness value; and
a nib array comprising a second material having a second hardness value greater than the first hardness value; the nib array further comprising a plurality of nibs connected by a lattice.

2. The surface protector of claim 1 wherein the mat and nib array are fused together.

3. The surface protector of claim 1 wherein the lattice is exposed on a surface of the mat.

4. The surface protector of claim 1 wherein the lattice embedded within the mat.

5. The surface protector of claim 1 wherein the plurality of nibs are equally spaced apart.

6. The surface protector of claim 1 wherein the lattice is configured as a rectangular grid.

7. The surface protector of claim 1 wherein the first material is a thermoplastic elastomer.

8. The surface protector of claim 1 wherein the second material is a glass-filled polypropylene.

9. A method for making a surface protector, the method comprising:
forming a nib array comprising a first material having a first hardness value, the nib array further comprising a plurality of nibs connected by a lattice; and
attaching a mat to the nib array, the mat comprising a second material having a second hardness value less than the first hardness value.

10. The method of claim 9 wherein forming the nib array comprises molding the nib array.

11. The method of claim 9 further comprising at least partially curing the nib array.

12. The method of claim 9 wherein attaching the mat to the nib array comprises fusing the mat to the nib array.

13. The method of claim 9 wherein attaching the mat to the nib array comprises positioning the nib array in a mold and introducing the second material into the mold.

14. The method of claim 9 wherein attaching the mat to the nib array comprises embedding the lattice in the second material.

15. A surface protector assembly comprising:
a plurality of rigid nibs;
a plurality of connectors that extend between and connect the plurality of rigid nibs.

16. The surface protector assembly of claim 15, and further comprising:
a mat portion.

17. The surface protector assembly of claim 16, wherein the plurality of rigid nibs and the mat portion are made from different materials.

18. The surface protector assembly of claim 17, wherein the plurality of connectors are made from the same material as the plurality of rigid nibs.

19. The surface protector assembly of claim 18, wherein the plurality of rigid nibs and the plurality of connectors are made from a polymer.

20. The surface protector assembly of claim 19, wherein the polymer comprises a glass-filled polypropylene.
